(19) United States
(12) Patent Application Publication
(10) Pub. No.: US 2025/0083275 A1
(43) Pub. Date: Mar. 13, 2025

(54) Machine Tool and Control Method for Machine Tool

(71) Applicant: DMG MORI CO., LTD., Nara (JP)

(72) Inventors: Haythem BOUJNAH, NARA (JP); Yuki YAMADA, NARA (JP); Yasuhiro IMABEPPU, NARA (JP); Naruhiro IRINO, NARA (JP)

(73) Assignee: DMG MORI CO., LTD., Nara (JP)

(21) Appl. No.: 18/827,366

(22) Filed: Sep. 6, 2024

(30) Foreign Application Priority Data
Sep. 12, 2023 (JP) 2023-147601

(51) Int. Cl. B23Q 17/09

(52) U.S. Cl. CPC B23Q 17/0957; B23Q 17/0966

(57) ABSTRACT

Provided is a technique for detecting at least wear of a tool. A machine tool includes a spindle that causes the tool to rotate, a housing that contains the spindle, a plurality of strain sensors provided on the housing, and a detector that detects wear or chipping of the tool, based on a waveform of a cutting force measured from an output signal from each of the plurality of strain sensors. The detector measures a waveform of a first cutting force, measures a waveform of a second cutting force, after measuring the waveform of the first cutting force, makes a comparison between the waveform of the first cutting force and the waveform of the second cutting force, and detects wear of the tool based on a result of the comparison.

### CROSS REFERENCE TO RELATED APPLICATIONS

This nonprovisional application is based on Japanese Patent Application No. 2023-147601 filed on Sep. 12, 2023, with the Japan Patent Office, the entire contents of which are hereby incorporated by reference.

### BACKGROUND OF THE INVENTION

### Field of the Invention

The present disclosure relates to a machine tool, and more particularly to a technique for detecting an abnormality of a tool.

### Description of the Background Art

A technique for measuring a force applied to a tool while a workpiece is machined (the force is hereinafter referred to as “cutting force”) has been developed. Regarding this technique, Japanese Patent Laying-Open No. 2022-106438 discloses a machine tool that measures, using a strain sensor, a cutting force applied to a tool. The strain sensor is provided on a flange of the machine tool to detect a cutting force applied to a tool attached to a spindle contained in the flange.

### SUMMARY OF THE INVENTION

According to an embodiment, a machine tool capable of cutting a workpiece using a tool is provided. The machine tool includes a spindle that causes the tool to rotate, a housing that contains the spindle, a plurality of strain sensors provided on the housing, and a detector that detects wear or chipping of the tool, based on a waveform of a cutting force measured from an output signal from each of the plurality of strain sensors. The detector measures a waveform of a first cutting force, measures a waveform of a second cutting force, after measuring the waveform of the first cutting force, makes a comparison between the waveform of the first cutting force and the waveform of the second cutting force, and detects wear of the tool based on a result of the comparison.

In an aspect, making the comparison between the waveform of the first cutting force and the waveform of the second cutting force includes: matching respective phases of the waveform of the first cutting force and the waveform of the second cutting force with each other; and calculating a difference between the waveform of the first cutting force and the waveform of the second cutting force after the respective phases are matched with each other. The detector detects chipping of the tool, based on the difference between the waveform of the first cutting force and the waveform of the second cutting force after the respective phases are matched with each other.

In an aspect, the detector normalizes the waveform of the first cutting force and the waveform of the second cutting force.

In an aspect, the detector detects wear of the tool, based on a fact that an amplitude of the waveform of the second cutting force is larger than an amplitude of the waveform of the first cutting force, by a predetermined threshold value or more.

In an aspect, the detector detects chipping of the tool, based on a fact that an amplitude of at least a part of the waveform of the second cutting force is smaller than an amplitude of at least a corresponding part of the waveform of the first cutting force, by a predetermined threshold value or more.

In an aspect, the tool includes a plurality of cutting edges. Each of the waveform of the first cutting force and the waveform of the second cutting force includes a plurality of amplitudes corresponding respectively to the plurality of cutting edges. Detecting wear or chipping of the tool includes comparing respective amplitudes corresponding to the same cutting edge that are included in the waveform of the first cutting force and the waveform of the second cutting force, respectively.

In an aspect, the waveform of the first cutting force and the waveform of the second cutting force are each a waveform of a cutting force at a position with the same machining condition, on a machining path for the workpiece.

According to another embodiment, a control method for a machine tool capable of cutting a workpiece using a tool is provided. Regarding the control method, the machine tool includes a spindle that causes the tool to rotate, a housing that contains the spindle, and a plurality of strain sensors provided on the housing. The control method includes: detecting wear or chipping of the tool, based on a waveform of a cutting force measured from an output signal from each of the plurality of strain sensors; measuring a waveform of a first cutting force; measuring a waveform of a second cutting force, after measuring the waveform of the first cutting force; making a comparison between the waveform of the first cutting force and the waveform of the second cutting force; and detecting wear of the tool based on a result of the comparison.

In an aspect, making the comparison between the waveform of the first cutting force and the waveform of the second cutting force includes: matching respective phases of the waveform of the first cutting force and the waveform of the second cutting force with each other; and calculating a difference between the waveform of the first cutting force and the waveform of the second cutting force after the respective phases are matched with each other. The control method further includes detecting chipping of the tool, based on the difference between the waveform of the first cutting force and the waveform of the second cutting force after the respective phases are matched with each other.

Further, according to another embodiment, a control program for a machine tool capable of cutting a workpiece using a tool is provided. Regarding the control program, the machine tool includes a spindle that causes the tool to rotate, a housing that contains the spindle, and a plurality of strain sensors provided on the housing. The control program causes the machine tool to perform: detecting wear or chipping of the tool, based on a waveform of a cutting force measured from an output signal from each of the plurality of strain sensors; measuring a waveform of a first cutting force; measuring a waveform of a second cutting force, after measuring the waveform of the first cutting force; making a comparison between the waveform of the first cutting force and the waveform of the second cutting force; and detecting wear of the tool based on a result of the comparison.

In an aspect, making the comparison between the waveform of the first cutting force and the waveform of the second cutting force includes: matching respective phases of the waveform of the first cutting force and the waveform of the second cutting force with each other; and calculating a difference between the waveform of the first cutting force and the waveform of the second cutting force after the respective phases are matched with each other. The control program further causes the machine tool to detect chipping of the tool, based on the difference between the waveform of the first cutting force and the waveform of the second cutting force after the respective phases are matched with each other.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing an example of a device configuration of a machine tool 10 according to the present embodiment.

FIG. 2 is a diagram showing an example of a configuration of a housing 133 according to the present embodiment.

FIG. 3 is a diagram showing an example of a cross section of housing 133.

FIG. 4 is a diagram showing an example of a procedure for calculating a cutting force using strain sensors.

FIG. 5 is a diagram showing an example of a configuration of a controller 50.

FIG. 6 is a diagram showing an example of a relation between a machining path for a workpiece and a cutting force, as well as an example of cutting forces to be compared with each other.

FIG. 7 is a diagram showing an example of a process for matching respective phases of waveforms of cutting forces to be compared with each other.

FIG. 8 is a diagram showing an example of normalization of respective waveforms of cutting forces to be compared with each other.

FIG. 9 is a diagram showing an example of a method for detecting wear of a tool.

FIG. 10 is a diagram showing an example of a method for detecting chipping of a tool.

FIG. 11 is a diagram showing an example of integration of respective waveforms of cutting forces to be compared with each other.

FIG. 12 is a diagram showing an example of a correlation between a waveform of a first cutting force and a waveform of a second cutting force.

FIG. 13 is a diagram showing an example of an internal process of machine tool 10.

FIG. 14 is a diagram showing an example of a configuration of a machine tool 1400 according to a modification.

### DESCRIPTION OF THE PREFERRED EMBODIMENTS

Embodiments of a technical idea according to the present disclosure are described hereinafter with reference to the drawings. In the following description, the same parts are denoted by the same reference characters. They have the same names and the same functions. Therefore, detailed description thereof is not herein repeated. Further, embodiments, modifications, respective configurations of software, respective configurations of hardware, functions, and processes, for example, may be selectively combined as appropriate.

### A. Device Configuration

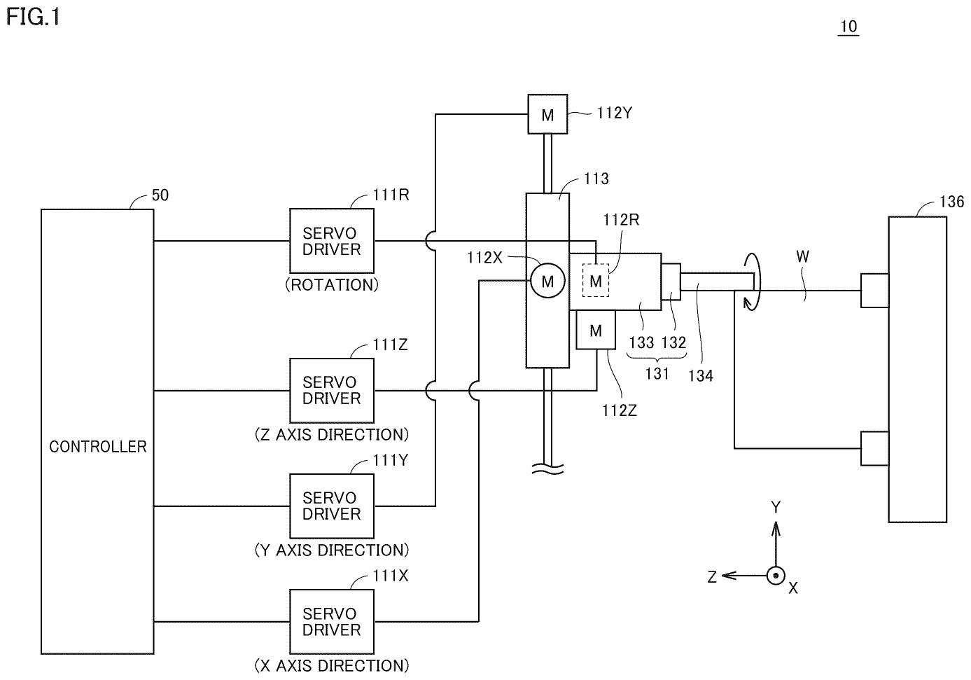

FIG. 1 is a diagram showing an example of a device configuration of a machine tool 10 according to the present embodiment. With reference to FIG. 1, a device configuration of machine tool 10 is described first. Machine tool 10 is any device that machines a workpiece. In one example, machine tool 10 may be a machining center. Machine tool 10 may also be a horizontal machining center or a vertical machining center. While machine tool 10 as a machining center is described hereinafter, machine tool 10 is not limited to the machining center. In an aspect, machine tool 10 may be a lathe, a milling machine, an additive manufacturing machine, or any of other cutting or grinding machines.

Machine tool 10 includes a controller 50, a servo driver 111R, servo drivers 111X to 111Z, a servo motor 112R, servo motors 112X to 112Z, a movable body 113, a spindle head 131, a tool 134, and a table 136.

“Controller 50” herein refers to a device that controls machine tool 10. Controller 50 may have any device configuration. Controller 50 may be composed of a single control unit or may be composed of a plurality of control units. In one example, controller 50 may include an NC (Numerical Control) unit and may include a PLC (Programmable Logic Controller).

Spindle head 131 is composed of a spindle 132 and a housing 133. Housing 133 contains spindle 132. A tool for machining a workpiece W to be machined is mounted on spindle 132. In the example of FIG. 1, tool 134 serving as an end mill is mounted on spindle 132. Tool 134 may include any tool other than the end mill, such as drill, tap, ball end mill, and the like.

In the following, the axial direction of spindle 132 is referred to as “Z direction,” the direction of gravity (i.e., the top-bottom direction in the sheet of the drawing) is referred to as “Y direction,” and the direction orthogonal to both the Z direction and the Y direction is referred to as “X direction.”

Controller 50 starts executing a machining program prepared in advance, in response to receiving a machining start command. Controller 50 controls servo driver 111R and servo drivers 111X to 111Z in accordance with the machining program. In this way, controller 50 causes workpiece W fixed to table 136 to be machined. The machining program is written with an NC program, for example.

Servo driver 111R sequentially receives an input of a target rotation speed from controller 50, and controls servo motor 112R (rotation drive unit). Servo motor 112R drives to rotate spindle 132 about an axis in the Z direction. More specifically, servo driver 111R acquires a feedback signal from an encoder (not shown) for detecting the rotation angle of servo motor 112R. Servo driver 111R calculates the actual rotation speed of servo motor 112R from the feedback signal. Servo driver 111R increases the rotation speed of servo motor 112R when the actual rotation speed of servo motor 112R is lower than the target rotation speed. Servo driver 111R lowers the rotation speed of servo motor 112R when the actual rotation speed of servo motor 112R is higher than the target rotation speed. In this way, servo driver 111R sequentially receives a feedback of the rotation speed of servo motor 112R, and makes the rotation speed of servo motor 112R closer to the target rotation speed.

Servo driver 111X sequentially receives an input of a target position from controller 50, and controls servo motor 112X. Servo motor 112X drives to feed movable body 113 to which spindle head 131 is attached, through a ball screw (not shown) or the like, and drives to feed spindle 132 to any position in the X direction. More specifically, servo driver 111X received a feedback signal from an encoder (not shown) for detecting the rotation angle of servo motor 112X. Servo driver 111X calculates the actual position of movable body 113 from the feedback signal. Servo driver 111X raises the actual position of servo motor 112X when the actual position of movable body 113 is lower than a target position. Servo driver 111X lowers the actual position of servo motor 112X when the actual position of movable body 113 is higher than the target position. In this way, servo driver 111X sequentially receives a feedback of the actual position of servo motor 112X, and makes the actual position of servo motor 112X closer to the target position. Thus, servo driver 111X drives to feed spindle 132 to any position in the X direction.

Servo driver 111Y sequentially receives an input of a target position from controller 50, and controls servo motor 112Y. Servo motor 112Y drives to feed movable body 113 to which spindle head 131 is attached, through a ball screw (not shown) or the like, and drives to feed spindle 132 to any position in the Y direction. The method for controlling servo motor 112Y by servo driver 111Y is similar to that by servo driver 111X, and therefore, the description thereof is not herein repeated.

Servo driver 111Z sequentially receives an input of a target position from controller 50, and controls servo motor 112Z. Servo motor 112Z drives to feed movable body 113 to which spindle head 131 is attached, through a ball screw (not shown) or the like, and drives to feed spindle 132 to any position in the Z direction. The method for controlling servo motor 112Z by servo driver 111Z is similar to that by servo driver 111X, and therefore, the description thereof is not herein repeated.

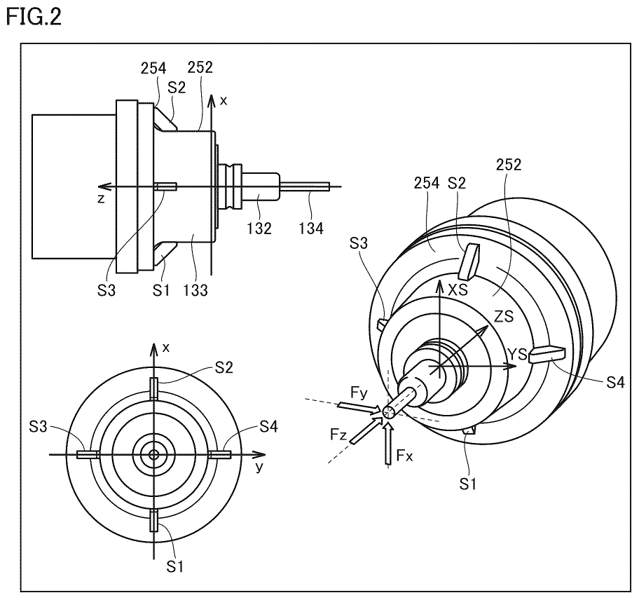

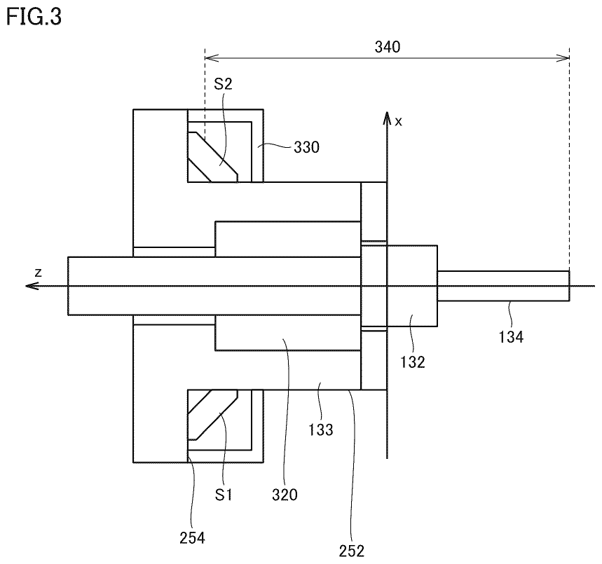

In machine tool 10 as described above, tool 134 repeats machining for a large number of workpieces. Accordingly, tool 134 is worn every time the tool repeats workpiece machining, and is eventually chipped. Input of an inappropriate setting to machine tool 10 may cause tool 134 to be chipped suddenly at an unexpected timing. “Chipping (chipped)” herein covers breakage of a part of a cutting edge and fracture of tool 134 itself. If tool 134 is worn or chipped, an operator of machine tool 10 has to replace tool 134. It is therefore desirable that machine tool 10 detects wear or chipping of tool 134 by a certain method and notifies the operator of the result of the detection. In order to implement the function of detecting wear or chipping of tool 134, machine tool 10 includes a plurality of strain sensors, as shown in FIGS. 2 and 3. Machine tool 10 measures a cutting force applied to tool 134, using a plurality of strain sensors, and detects wear or chipping of tool 134 based on the cutting force.

FIG. 2 is a diagram showing an example of a configuration of housing 133 according to the present embodiment. With reference to FIG. 3, strain sensors attached to housing 133 and the cutting force applied to tool 134 are described.

As described above, housing 133 contains spindle 132. Spindle 132 is rotated at a high speed inside housing 133, by motive power transmitted from servo motor 112R. Housing 133 has a first surface 252 and a second surface 254. As shown in FIG. 2, first surface 252 and second surface 254 intersect at a right angle. Housing 133 shown in FIG. 2 is one example, and first surface 252 and second surface 254 may not intersect at an exact right angle.

Housing 133 is configured in such a manner that allows a plurality of strain sensors to be attached thereto. The strain sensor is attached to housing 133, for example, to contact both of first surface 252 and second surface 254. One end of the strain sensor is connected to first surface 252. The other end of the strain sensor is connected to second surface 254. That is, the strain sensor is attached to first surface 252 and second surface 254 in a form like a rib. In an aspect, the strain sensor may be configured in such a manner that the strain sensor is attachable to and detachable from first surface 252 and second surface 254.

In the example of FIG. 2, strain sensors S1 to S4 are attached to housing 133. More specifically, strain sensor S1 and strain sensor S2 are arranged along the X direction. Strain sensor S3 and strain sensor S4 are arranged along the Y direction. That is, each strain sensor is offset by 90 degrees from each of the adjacent strain sensors. In an aspect, there may be a gap between the strain sensor and a corner formed by first surface 252 and second surface 254. In another aspect, there may be no gap between the strain sensor and the corner formed by first surface 252 and second surface 254.

Next, the cutting force applied to tool 134 is described. It is assumed that machine tool 10 cuts a workpiece W using an end mill. In this case, machine tool 10 presses the tip of tool 134 against workpiece W while rotating tool 134. Tool 134 receives a repulsive force from workpiece W. This force acts as a cutting force. A cutting force Fx in the X direction, a cutting force Fy in the Y direction, and a cutting force Fz in the Z direction are applied to tool 134.

Controller 50 can measure cutting force Fx in the X direction, based on output signals acquired from strain sensor S1 and strain sensor S2. Controller 50 can also measure cutting force Fy in the Y direction, based on output signals acquired from strain sensor S3 and strain sensor S4. Further, controller 50 can measure cutting force Fz in the Z direction, based on respective output signals acquired from strain sensors S1 to S4. These measured cutting forces are used for detecting wear or chipping of tool 134.

While the number of strain sensors is four according to the above description of the example of FIG. 2, the number of strain sensors attached to housing 133 is not limited to this. In an aspect, housing 133 may be configured to allow three or less than three strain sensors to be attached to the housing. In another aspect, housing 133 may be configured to allow five or more than five strain sensors to be attached to the housing. In this case, controller 50 can appropriately change an equation for calculating cutting forces Fx, Fy, and Fz, depending on arrangement of the strain sensors and the number of the strain sensors. The equation for calculating cutting forces Fx, Fy, and Fz can be implemented as a program.

FIG. 3 is a diagram showing an example of a cross section of housing 133. A positional relation between the strain sensors and tool 134 is described with reference to FIG. 3. Further, an advantage derived from attaching the strain sensors to housing 133 is described.

Housing 133 contains spindle 132 with a bearing 320 interposed therebetween. Bearing 320 may be formed integrally with housing 133 or spindle 132. Bearing 320 may also be formed as a part independent of housing 133 and spindle 132. Further, housing 133 is configured to allow a cover 330 for protecting the strain sensor to be attached to the housing. The number of covers 330 that can be attached to housing 133 is equal to the number of the strain sensors that can be attached thereto.

As described above, the strain sensor is attached to second surface 254 located near the proximal end of housing 133. Therefore, a distance 340 from the tip of tool 134 to the strain sensor is relatively long. When a cutting force is generated at the tip of tool 134, a portion of housing 133 that is farther from the tip of tool 134 is strained to a greater extent than a portion thereof that is closer to the tip of tool 134. Thus, the strain sensor located farther from the tip of tool 134 can measure strain with high sensitivity. Accordingly, controller 50 can measure the cutting force with high accuracy from the output signal of the strain sensor. Further, since housing 133 is configured to allow the strain sensor to be attached to the housing, an operator can easily attach and detach the strain sensor.

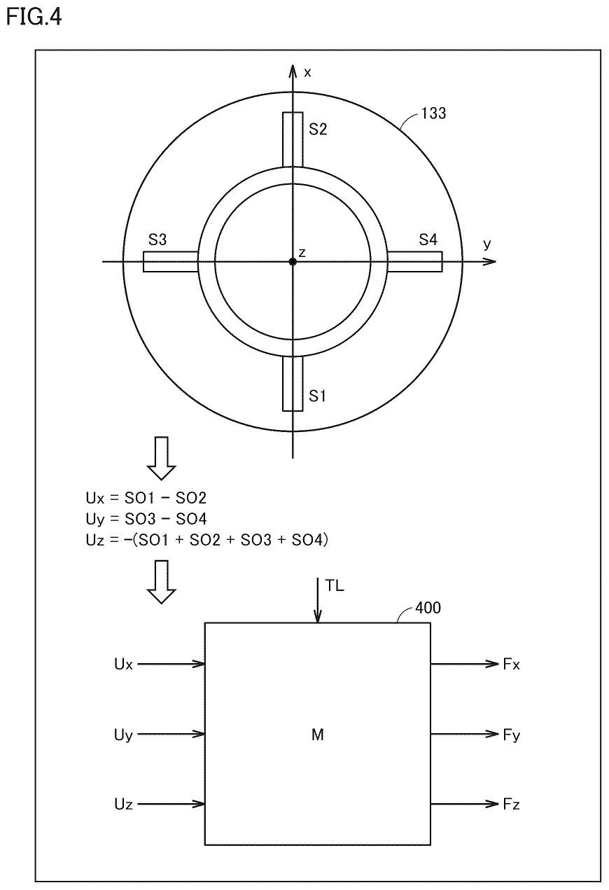

FIG. 4 is a diagram showing an example of a procedure for calculating a cutting force using strain sensors. A method for measuring each of cutting force Fx in the X direction, cutting force Fy in the Y direction, and cutting force Fz in the Z direction is described with reference to FIG. 4.

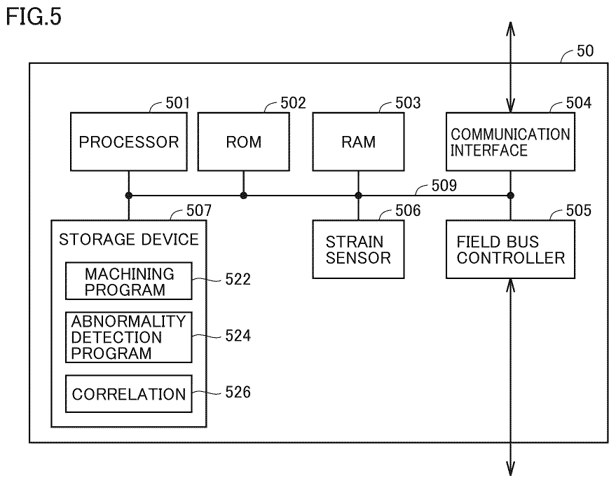

A cutting force measurement module 400 shown in FIG. 4 is a program for measuring cutting forces Fx, Fy, and Fz. In an aspect, cutting force measurement module 400 may be implemented as a part of an abnormality detection program 524 (see FIG. 5). In another aspect, cutting force measurement module 400 may be implemented as a program separate from abnormality detection program 524 (see FIG. 5). In this case, abnormality detection program 524 cooperates with cutting force measurement module 400. Controller 50 can perform the following process using cutting force measurement module 400.

As described above, strain sensor S1 and strain sensor S2 are arranged along the X direction. Therefore, in an XY plane, strain sensor S1 and strain sensor S2 detect only the strain in the X direction. While strain sensor S1 and strain sensor S2 may also be influenced by strain in the Y axis direction actually, the influence of the strain in the Y axis direction is smaller. Therefore, controller 50 can calculate (measure) cutting force Fx in the X direction, based on a synthetic value Ux of an output signal SO1 of strain sensor S1 and an output signal SO2 of strain sensor S2. In one example, synthetic value Ux may be calculated by an equation “SO1-SO2.” More specifically, controller 50 inputs synthetic value Ux to cutting force measurement module 400. Cutting force measurement module 400 calculates cutting force Fx by multiplying synthetic value Ux by a gain TL. Alternatively, cutting force measurement module 400 may calculate cutting force Fx by substituting synthetic value Ux and gain TL in a function. In an aspect, SO1 and SO2 may be input to cutting force measurement module 400. In this case, cutting force measurement module 400 calculates synthetic value Ux from SO1 and SO2. Cutting force measurement module 400 may also calculate (measure) synthetic value Ux using data 526 (see FIG. 5) of a correlation between strain and the cutting force. In this case, correlation data 526 may include information on gain TL and the function. Cutting force measurement module 400 may also calculate (measure) Ux from a table or equation of a correlation between strain and the cutting force.

Strain sensor S3 and strain sensor S4 are arranged along the Y direction. Therefore, in an XY plane, strain sensor S3 and strain sensor S4 detect only the strain in the Y direction. While strain sensor S3 and strain sensor S4 may also be influenced by strain in the Z axis direction actually, the influence of the strain in the X axis direction is smaller. Therefore, controller 50 can calculate (measure) cutting force Fy in the Y direction, based on a synthetic value Uy of an output signal SO3 of strain sensor S1 and an output signal SO4 of strain sensor S2. In one example, synthetic value Uy may be calculated by an equation “SO3-SO4.” More specifically, controller 50 inputs synthetic value Uy to cutting force measurement module 400. Cutting force measurement module 400 calculates cutting force Fy by multiplying synthetic value Uy by gain TL. Alternatively, cutting force measurement module 400 may calculate cutting force Fy by substituting synthetic value Uy and gain TL in a function. In an aspect, SO3 and SO4 may be input to cutting force measurement module 400. In this case, cutting force measurement module 400 calculates synthetic value Uy from SO3 and SO4. Cutting force measurement module 400 may also calculate (measure) synthetic value Uy using data 526 of the correlation between strain and the cutting force. In this case, correlation data 526 may include information on gain TL and the function. Cutting force measurement module 400 may also calculate (measure) Uy from a table or equation of a correlation between strain and the cutting force.

Strain sensors S1 to S4 are all strained in the Z axis direction. Therefore, controller 50 can calculate (measure) cutting force Fz in the Z direction, based on a synthetic value Uz of output signals SO1 to SO4 of strain sensors S1 to S4. In one example, synthetic value Uz may be calculated by an equation “−(SO1+SO2+SO3+SO4).” More specifically, controller 50 inputs synthetic value Uz to cutting force measurement module 400. Cutting force measurement module 400 calculates cutting force Fz by multiplying synthetic value Uz by gain TL. Alternatively, cutting force measurement module 400 may calculate cutting force Fz by substituting synthetic value Uz and gain TL in a function. In an aspect, SO1 to SO4 may be input to cutting force measurement module 400. In this case, cutting force measurement module 400 calculates synthetic value Uz from SO1 to SO4. Cutting force measurement module 400 may also calculate (measure) synthetic value Uz using data 526 of the correlation between strain and the cutting force. In this case, correlation data 526 may include information on gain TL and the function. Cutting force measurement module 400 may also calculate (measure) Uz from a table or equation of a correlation between strain and the cutting force.

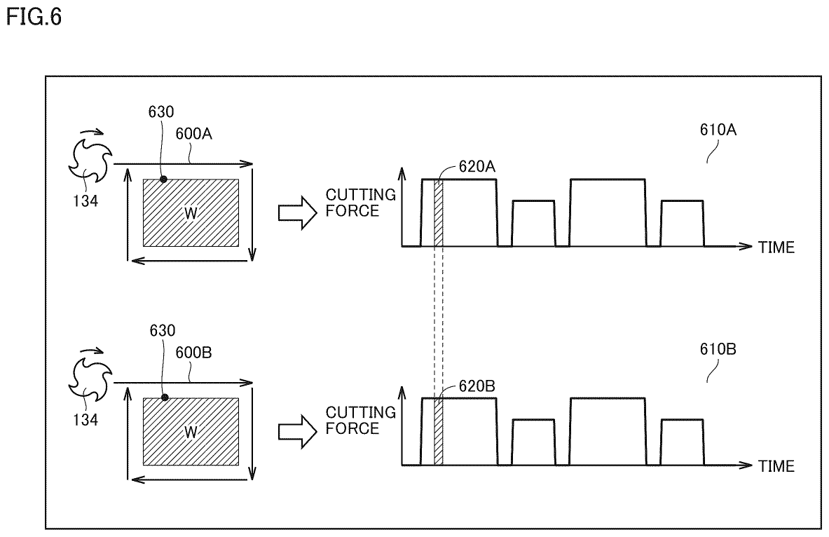

Controller 50 may calculate a synthetic cutting force from cutting forces Fx, Fy, and Fz in the respective directions. In this case, controller 50 may treat the synthetic cutting force as a cutting force applied to tool 134 and perform the process illustrated in FIG. 6 and the subsequent drawings. In an aspect, controller 50 may calculate a synthetic cutting force of any two of cutting forces Fx, Fy, and Fz. In this case, controller 50 treats the synthetic cutting force composed of the two cutting forces as a cutting force applied to tool 134, and can perform the process illustrated in FIG. 6 and the subsequent drawings. In another aspect, controller 50 may treat any one of cutting forces Fx, Fy, and Fz as a cutting force applied to tool 134, and perform the process illustrated in FIG. 6 and the subsequent drawings. The above-described process for calculating the synthetic cutting force may also be performed by cutting force measurement module 400.

FIG. 5 is a diagram showing an example of a configuration of controller 50. Next, a hardware configuration of controller 50 is described with reference to FIG. 5. In an aspect, controller 50 may be a CNC (Computer Numerical Control) unit, a CNC controller, a PLC, or any information processing device.

Controller 50 includes a processor 501, a ROM (Read Only Memory) 502, a RAM (Random Access Memory) 503, a communication interface 504, a field bus controller 505, a storage device 507, and one or more strain sensors 506. These components are connected to an internal bus 509. One or more strain sensors 506 correspond to strain sensors S1 to S4. In an aspect, controller 50 may be configured to communicate with external strain sensors, instead of including one or more strain sensors 506.

Processor 501 is configured as at least one integrated circuit, for example. The integrated circuit may be configured as at least one CPU (Central Processing Unit), at least one GPU (Graphics Processing Unit), at least one ASIC (Application Specific Integrated Circuit), at least one FPGA (Field Programmable Gate Array), or a combination of them.

Processor 501 controls operation of controller 50 by executing various programs such as a machining program 522 and abnormality detection program 524. In response to receiving an instruction to execute various programs, processor 501 reads the programs from storage device 507 or ROM 502 to RAM 503. RAM 503 functions as a working memory, and temporarily stores various data necessary for executing the programs.

Communication interface 504 is configured to communicate with an external device. A LAN, an antenna, or the like is connected to communication interface 504. Controller 50 exchanges data with an external device (for example, a server or the like) through communication interface 504. Controller 50 may be configured to download machining program 522, abnormality detection program 524, and correlation data 526 from the external device.

Field bus controller 505 is an interface for implementing communication with various units connected to the field bus. Examples of the units connected to the field bus include a PLC and an I/O unit.

Storage device 507 is, for example, any storage medium such as hard disk, flash memory, or SSD (Solid State Drive). Storage device 507 stores machining program 522, abnormality detection program 524, and correlation data 526, for example.

Machining program 522 defines various instructions for implementing machining of a workpiece. Abnormality detection program 524 detects wear or chipping of tool 134. Abnormality detection program 524 also has a function of acquiring output signals of strain sensors S1 to S4 and measuring (calculating) the cutting force. Correlation data 526 represents a correlation between output values of strain sensors S1 to S4 and the cutting force. The correlation may be defined in a table form or may be defined by a predetermined equation. The equation has the output values of strain sensors S1 to S4 as explanatory variables, and the cutting force applied to the tool as a response variable, for example. The table or equation of correlation data 526 may be modified as appropriate, based on the number and arrangement of the strain sensors. Processor 501 can perform the process illustrated in FIGS. 4 and 6 to 13 by referring to correlation data 526 and executing abnormality detection program 524.

The locations where machining program 522, abnormality detection program 524, and correlation data 526 are stored are not limited to storage device 507. In an aspect, machining program 522, abnormality detection program 524, and correlation data 526 may be stored in a storage area of processor 501, ROM 502, RAM 503, an external device, or the like.

Abnormality detection program 524 may be provided by being incorporated into a part of any program, rather than being provided as a single program. In this case, an abnormality detection process (a process for detecting wear or chipping of tool 134) by abnormality detection program 524 is implemented through cooperation with any program. Even such a program that does not include some modules does not depart from the essence of abnormality detection program 524 according to the present embodiment. Further, some or all of functions provided by abnormality detection program 524 may be implemented by dedicated hardware. Further, at least one server may perform a part of the process of abnormality detection program 524. In this case, machine tool 10 is configured to communicate with a server having a part of the functions of abnormality detection program 524.

### B. Method for Detecting Wear or Chipping

Next, a specific procedure for machine tool 10 to detect wear or chipping of tool 134 is described with reference to FIGS. 6 to 12. Controller 50 can perform a process for detecting an abnormality of tool 134, by referring to correlation data 526 and executing abnormality detection program 524.

FIG. 6 is a diagram showing an example of a relation between a machining path for a workpiece and a cutting force, as well as an example of cutting forces to be compared with each other. As described below, machine tool 10 detects wear or chipping of tool 134, based on a change of a part of the waveform of the cutting force on the machining path for tool 134.

Machine tool 10 machines a workpiece based on machining program 522. Machining program 522 is an NC program or the like. Machining program 522 specifies a machining path for tool 134. For example, as shown in FIG. 6, it is assumed that machine tool 10 cuts a workpiece into a square shape. In this case, tool 134 moves to repeat the round on the same machining path (rectangular path). Actually, machine tool 10 slightly moves spindle head 131 in the Z axis direction, every time tool 134 makes one round on the machining path.

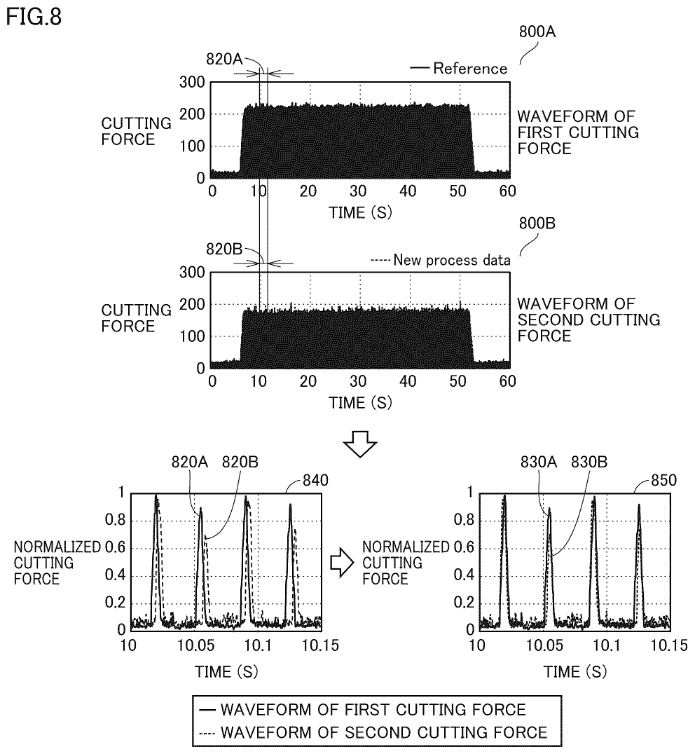

A machining path 600A is an initial machining path. A waveform 610A of the cutting force is a waveform of the cutting force corresponding to machining path 600A. A machining path 600B is a path for the cutting force for the second and subsequent times. A waveform 610B of the cutting force is a waveform of the cutting force corresponding to machining path 600B. While waveforms 610A and 610B of the cutting force are simplified waveforms, actual waveforms are those like waveforms 800A and 800B of the cutting force in FIG. 8.

Machine tool 10 stores, in RAM 503, a waveform 620A of a first cutting force corresponding to any position 630 on machining path 600A, as a reference waveform. Next, machine tool 10 stores, in RAM 503, a waveform 620B of a second cutting force corresponding to position 630 on machining path 600B. Position 630 may not be a point but be a section having a certain length. Next, machine tool 10 compares waveform 620A (reference waveform) of the first cutting force with waveform 620B of the second cutting force. Then, machine tool 10 detects how the cutting force has changed, based on the result of the comparison. Further, machine tool 10 detects wear or chipping of tool 134, based on a change of the waveform of the cutting force. That is, machine tool 10 compares respective waveforms of the cutting forces at the same position where the same machining condition is applied, on the machining path for the workpiece. The machining condition includes any settings relating to machining, such as the number of rotations, the depth of cut, the distance of feed, and the coordinates of tool 134.

Machine tool 10 repeatedly compares waveform 620A (reference waveform) of the first cutting force with waveform 620B of the second cutting force. For example, it is assumed that tool 134 moves to make 100 rounds on the machining path. In this case, machine tool 10 may compare waveform 620A of the first cutting force for the first machining with each of waveforms 620B of the second cutting force for the second to 100th machining. In an aspect, machine tool 10 may compare waveform 620A of the first cutting force with waveform 620B of the second cutting force, every time machining is performed specific number of times (e.g., ten times) along the machining path. In another aspect, machine tool 10 may compare waveform 620A (reference waveform) of the first cutting force for the first machining with an average value of waveforms 620B of the second cutting force for machining performed multiple times, i.e., the second and subsequent machining.

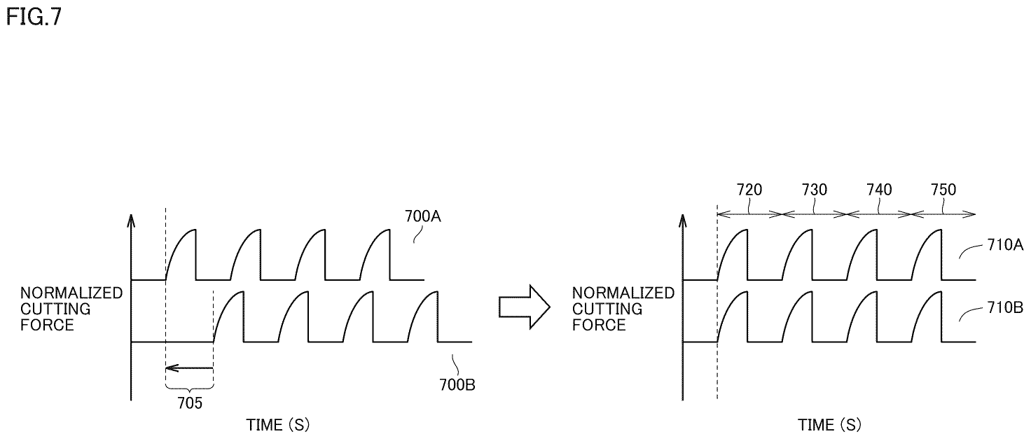

FIG. 7 is a diagram showing an example of a process for matching respective phases of waveforms of cutting forces to be compared with each other. As shown in FIG. 6, machine tool 10 repeatedly compares the waveform (reference waveform) of the first cutting force with the waveform of the second cutting force at the same machining position. However, the phase of the waveform of the cutting force acquired by machine tool 10 may be shifted slightly every time the waveform is acquired. Therefore, machine tool 10 matches respective phases of the waveform of the first cutting force and the waveform of the second cutting force with each other. As described with reference to FIG. 8, machine tool 10 may normalize the waveform of the first cutting force and the waveform of the second cutting force and then match respective phases with each other.

A waveform 700A of the first cutting force is obtained by normalizing waveform 620A of the first cutting force based on the maximum value. A waveform 700B of the second cutting force is obtained by normalizing waveform 620B of the second cutting force based on the maximum value. It is seen, from a comparison between waveform 700A of the first cutting force and waveform 700B of the second cutting force, that there is a phase shift 705. Machine tool 10 cannot compare waveform 700A of the first cutting force with waveform 700B of the second cutting force in this state. Therefore, machine tool 10 matches respective phases of waveform 700A of the first cutting force and waveform 700B of the second cutting force with each other. A waveform 710A of the first cutting force is a waveform obtained after the process of phase matching with the phase of waveform 700A of the first cutting force. A waveform 710B of the second cutting force is a waveform obtained after the process of phase matching with the phase of waveform 700B of the second cutting force.

In an aspect, machine tool 10 may match the rise position of the amplitude of waveform 700A of the first cutting force with the rise position of the amplitude of waveform 700B of the second cutting force. In another aspect, machine tool 10 may match the peak of the amplitude of waveform 700A of the first cutting force with the peak of the amplitude of waveform 700B of the second cutting force. Further, in still another aspect, machine tool 10 may use any means to match respective phases of waveform 700A of the first cutting force and waveform 700B of the second cutting force. The amplitude of the waveform of the cutting force represents the cutting force. Therefore, in the following description, the amplitude of the waveform of the cutting force may be identified as the cutting force. For example, the amplitude of the waveform of the first cutting force may be identified as the first cutting force. Moreover, the waveform of the cutting force represents a change of the magnitude of the cutting force (the cutting force in a certain section). Therefore, the waveform of the cutting force may be expressed as the cutting force. For example, comparing the waveform of the first cutting force with the waveform of the second cutting force is equivalent to comparing the first cutting force with the second cutting force. Similarly, calculating the difference between the waveform of the first cutting force and the waveform of the second cutting force is equivalent to calculating the difference between the first cutting force and the second cutting force.

The waveforms of sections 720 to 750 with an increased amplitude are waveforms representing the cutting force applied to each cutting edge. For example, it is assumed that tool 134 includes two cutting edges. In this case, the waveforms of sections 720 and 740 represent the cutting force applied to a first cutting edge of tool 134. The waveforms of sections 730 and 750 represent the cutting force applied to a second cutting edge of tool 134. Machine tool 10 can compare waveform 710A of the first cutting force with waveform 710B of the second cutting force for each cutting edge, by matching respective phases of the waveforms of the two cutting forces with each other. For example, machine tool 10 may compare the waveform of section 720 of waveform 700A of the first cutting force, with the waveform of section 720 of waveform 710B of the second cutting force. That is, machine tool 10 can precisely detect a change of the cutting force for each cutting edge, by matching respective phases of the waveforms of the two cutting forces with each other.

As described above, machine tool 10 capable of cutting a workpiece using tool 134 includes: spindle 132 that causes tool 134 to rotate; housing 133 that contains spindle 132; a plurality of strain sensors S1 to S4 provided on housing 133; and a detector (controller 50) that detects wear or chipping of tool 134, based on a waveform of a cutting force measured from an output signal from each of the plurality of strain sensors S1 to S4. The detector (controller 50) measures a waveform of a first cutting force, measures a waveform of a second cutting force, after measuring the waveform of the first cutting force, makes a comparison between the waveform of the first cutting force and the waveform of the second cutting force, and detects wear of the tool based on a result of the comparison. The detector (controller 50) can detect wear of tool 134 by comparing a change in the magnitude of the overall amplitude of the waveform of the first cutting force with that of the waveform of the second cutting force. Therefore, when only wear is to be detected without detecting chipping of tool 134, the detector (controller 50) may not match respective phases of the waveform of the first cutting force and the waveform of the second cutting force with each other.

In an aspect, in order to detect chipping of tool 134, the detector (controller 50) may match respective phases of the waveform of the first cutting force and the waveform of the second cutting force with each other. That is, making the comparison between the waveform of the first cutting force and the waveform of the second cutting force includes matching respective phases of the waveform of the first cutting force and the waveform of the second cutting force with each other, and calculating a difference between the waveform of the first cutting force and the waveform of the second cutting force after the respective phases are matched with each other. The detector (controller 50) detects chipping of tool 134, based on the difference between the waveform of the first cutting force and the waveform of the second cutting force after respective phases are matched with each other. Thus, the detector (controller 50) can detect not only wear of tool 134 but also chipping of tool 134 by matching respective phases of the waveform of the first cutting force and the waveform of the second cutting force with each other.

In an aspect, machine tool 10 may notify an operator of wear or chipping of tool 134. In one example, machine tool 10 may display the notification on a display (not shown) provided on machine tool 10. In another example, machine tool 10 may transmit the notification to a terminal or the like of an operator through a network. In another aspect, machine tool 10 may replace broken tool 134 with a new tool, in response to detecting wear or chipping of tool 134. As described above, the waveform of the cutting force represents the cutting force itself. Therefore, comparing respective waveforms of the cutting forces is equivalent to comparing these cutting forces. Therefore, machine tool 10 may also be regarded as detecting wear or chipping of tool 134, based on the difference between the first cutting force and the second cutting force after respective phases are matched with each other.

Tool 134 may include a plurality of cutting edges. In this case, each of the waveform of the first cutting force and the waveform of the second cutting force includes a plurality of amplitudes corresponding respectively to the plurality of cutting edges. Detecting wear or chipping of tool 134 includes comparing respective amplitudes corresponding to the same cutting edge that are included in the waveform of the first cutting force and the waveform of the second cutting force, respectively. In one example, tool 134 may include a plurality of cutting edges such as a first cutting edge and a second cutting edge. In this case, each of the waveform of the first cutting force and the waveform of the second cutting force includes a first amplitude (first cutting force) corresponding to the first cutting edge and a second amplitude (second cutting force) corresponding to the second cutting edge. Detecting wear or chipping of tool 134 includes comparing the first amplitude (first cutting force) included in the waveform of the first cutting force with the first amplitude (first cutting force) included in the waveform of the second cutting force, and comparing the second amplitude (second cutting force) included in the waveform of the first cutting force with the second amplitude (second cutting force) included in the waveform of the second cutting force. In another example, tool 134 may include three or more cutting edges. For example, tool 134 may include N (any integer) cutting edges. In this case, detecting wear or chipping of tool 134 includes comparing the first to Nth amplitudes included in the waveform of the first cutting force with the first to Nth amplitudes included in the waveform of the second cutting force, respectively.

Further, as described above with reference to FIG. 6, the waveform of the first cutting force and the waveform of the second cutting force are each a waveform of a cutting force at a position with the same machining condition, on a machining path for the workpiece. In an aspect, the waveform of the first cutting force and the waveform of the second cutting force may be a synthetic value (integral value, average value, or the like) of waveforms of the cutting forces at the position with the same machining condition. In another aspect, the waveform of the first cutting force and the waveform of the second cutting force may be the cutting forces (Fx, Fy, and Fz) of the respective vectors (axes) at the position with the same machining condition, or the sum of these forces.

FIG. 8 is a diagram showing an example of normalization of respective waveforms of cutting forces to be compared with each other. Machine tool 10 normalizes the acquired waveform of the cutting force. Normalization is a process of arranging the data in unit that is easy to treat. Machine tool 10 can normalize the magnitude (amplitude) of the cutting force. In one example, machine tool 10 may scale the range of the magnitude (amplitude) of the cutting force to 0 to 1. The minimum value and the maximum value may be any values. Further, machine tool 10 may normalize both the magnitude (amplitude) of the cutting force and the cutting time. By normalizing the acquired waveform of the cutting force, machine tool 10 can detect chipping of various tools using the same reference (threshold value or the like).

A waveform 800A of a cutting force represents a waveform of the initial cutting force on a certain machining path. A waveform 800B of a cutting force represents a waveform of the second and subsequent cutting forces on the certain machining path. It is assumed that machine tool 10 compares a waveform 820A of the first cutting force with a waveform 820B of the second cutting force at the same position on the machining path. In this case, as shown in a waveform graph 840, machine tool 10 normalizes waveform 820A of the first cutting force to generate a normalized waveform 830A of the first cutting force. Similarly, machine tool 10 normalizes waveform 820B of the second cutting force to generate a normalized waveform 830B of the second cutting force. Next, as shown in a waveform graph 850, machine tool 10 matches the phase of normalized waveform 830A of the first cutting force with the phase of normalized waveform 830B of the second cutting force. In an aspect, machine tool 10 may normalize the waveforms after matching respective phases of waveform 820A of the first cutting force and waveform 820B of the second cutting force.

The above process is performed by controller 50. That is, the detector (controller 50) normalizes the waveform of the first cutting force and the waveform of the second cutting force. Then, the detector (controller 50) matches respective phases of the normalized waveform of the first cutting force and the normalized waveform of the second cutting force.

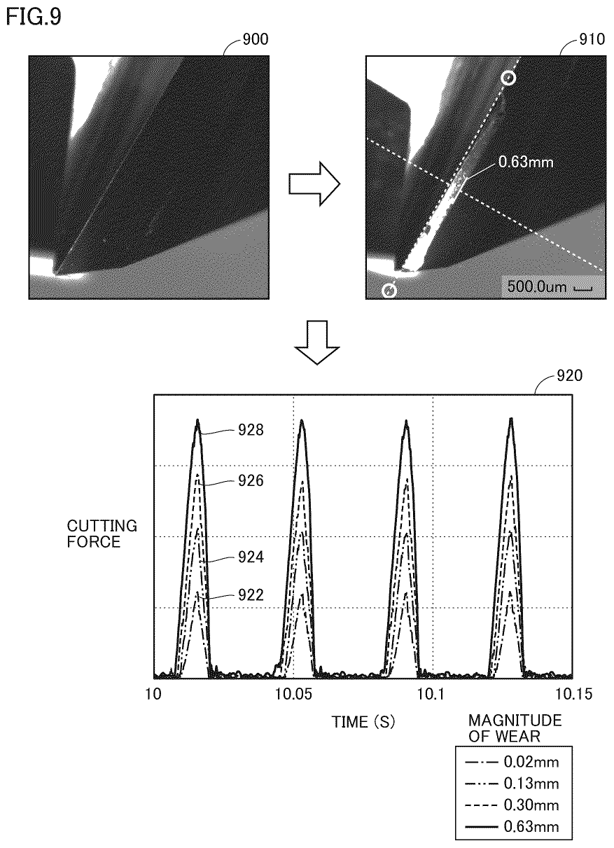

FIG. 9 is a diagram showing an example of a method for detecting wear of a tool. Next, how the cutting force applied to tool 134 changes due to wear of tool 134 is described with reference to FIG. 9.

A photograph 900 shows a new cutting edge of tool 134. A photograph 910 shows a worn cutting edge of tool 134. The worn cutting edge like the one in photograph 910 has its cutting edge scraped off. Therefore, the worn cutting edge receives a larger resistance when cutting a workpiece, as compared with the new cutting edge. That is, when the cutting edge of tool 134 is not worn, the cutting force applied to tool 134 is small. As the cutting edge of tool 134 wears, the cutting force applied to tool 134 increases.

A waveform graph 920 shows an example of a relation between wear of tool 134 and the cutting force. A waveform 922 of the cutting force is a waveform when the flank wear width is “0.02 mm.” A waveform 924 of the cutting force is a waveform when the flank wear width is “0.13 mm.” A waveform 926 of the cutting force is a waveform when the flank wear width is “0.30 mm.” A waveform 928 of the cutting force is a waveform when the flank wear width is “0.63 mm.” It is seen, from a comparison of waveforms 922 to 928 of the cutting force with each other, the greater the wear of tool 134, the greater the overall amplitude of the cutting force.

Machine tool 10 determines whether or not the amplitude of the waveform of the second cutting force has become larger than the amplitude of the waveform of the first cutting force (reference waveform) by a predetermined threshold value or more. Then, machine tool 10 detects wear of tool 134 based on the fact that the difference between the amplitude of the waveform of the first cutting force and the amplitude of the waveform of the second cutting force (the difference between the first cutting force and the second cutting force) is equal to or greater than the threshold value. That is, the detector (controller 50) detects wear of tool 134 based on the fact that the amplitude of the waveform of the second cutting force is larger than the amplitude of the waveform of the first cutting force by a predetermined threshold value or more.

In an aspect, machine tool 10 may determine, for each cutting edge, whether or not the amplitude of the waveform of the second cutting force has become larger than the amplitude of the waveform of the first cutting force (reference waveform) by a predetermined threshold value or more. In this case, in one example, machine tool 10 determines whether or not the amplitude of the waveform of the cutting force on the first cutting edge of tool 134 has increased by a predetermined threshold value or more, as compared with the amplitude of the reference waveform. The reference waveform in this case is a reference waveform of the cutting force on the first cutting edge (a waveform of the initial cutting force). Similarly, machine tool 10 determines whether or not the amplitude of the waveform of the cutting force on the second cutting edge of tool 134 has increased by a predetermined threshold value or more, as compared with the amplitude of the reference waveform. The reference waveform in this case is a reference waveform of the cutting force on the second cutting edge (a waveform of the initial cutting force).

In another aspect, machine tool 10 may determine, for each tool, whether or not the amplitude of the waveform of the second cutting force has become larger than the amplitude of the waveform of the first cutting force (reference waveform) by a predetermined threshold value or more. In this case, in one example, machine tool 10 determines whether or not an average value of the amplitude of the waveform of the cutting force on each cutting edge of tool 134 has increased by a predetermined threshold value or more, as compared with an average value of the amplitude of the reference waveform. The reference waveform in this case is a reference waveform of the cutting force at each cutting edge (waveform of the initial cutting force).

In an aspect, machine tool 10 may also compare the maximum value of the amplitude of the waveform of the first cutting force (the apex of the wave) with the maximum value of the amplitude of the waveform of the second cutting force. In another aspect, machine tool 10 may compare an integral value of the amplitude of the waveform of the first cutting force with an integral value of the amplitude of the waveform of the second cutting force.

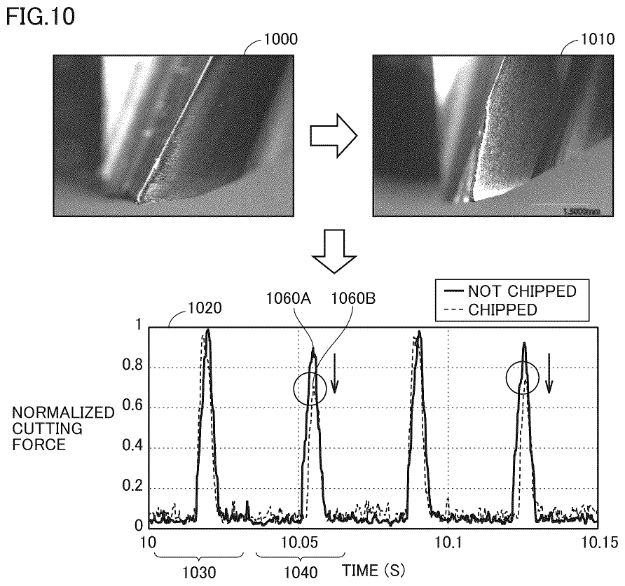

FIG. 10 is a diagram showing an example of a method for detecting chipping of a tool. With reference to FIG. 10, how the cutting force applied to tool 134 changes due to chipping of tool 134 is described.

A photograph 1000 shows a new cutting edge of tool 134. A photograph 1010 shows a chipped cutting edge of tool 134. The area of the chipped cutting edge as shown in photograph 1010 that is engaged in a workpiece is smaller than that of the new cutting edge of the tool as shown in photograph 1000. Therefore, the chipped cutting edge receives a smaller cutting force when cutting the workpiece, as compared with the cutting edge of the new tool. That is, when the cutting edge of tool 134 is not chipped, the cutting force applied to tool 134 is relatively large. When the cutting edge of tool 134 is chipped, the cutting force applied to tool 134 becomes small.

A waveform graph 1020 shows an example of a relation between chipping of tool 134 and the cutting force. The waveform in a section 1030 represents the waveform of the cutting force of a first cutting edge. The waveform in a section 1040 represents the waveform of the cutting force of a second cutting edge. In the example of FIG. 10, the second cutting edge is chipped. Referring to section 1030, there is no significant change in the waveform of the cutting force before and after the occurrence of chipping. This is for the reason that the first cutting edge is not chipped. In contrast, referring to section 1040, it is seen that the amplitude of the waveform of the cutting force changes to a large extent as compared with the amplitude of the waveform before and after the occurrence of chipping. A waveform 1060A represents the cutting force of the second cutting edge before being chipped. A waveform 1060B represents the cutting force of the second cutting edge after being chipped. It is seen, from a comparison between waveform 1060A and waveform 1060B, the cutting force applied to tool 134 has been decreased considerably, due to the chipping of the cutting edge.

As described above, machine tool 10 determines whether or not the amplitude of the waveform of the second cutting force is smaller than the amplitude of the waveform of the first cutting force (reference waveform) by a predetermined threshold value or more. Then, machine tool 10 detects chipping of tool 134, based on the fact that the difference between the amplitude of the waveform of the first cutting force and the amplitude of the waveform of the second cutting force is equal to or greater than a threshold value. That is, the detector (controller 50) detects chipping of tool 134, based on the fact that the amplitude of at least a part of the waveform of the second cutting force is smaller than the amplitude of at least a corresponding part of the waveform of the first cutting force by a predetermined threshold value or more. The amplitude of at least a part of the waveform of the second cutting force is, for example, the amplitude of the cutting force of a certain cutting edge included in the waveform of the second cutting force. The amplitude of at least a corresponding part of the waveform of the first cutting force is, for example, the amplitude of the cutting force of the certain cutting edge included in the waveform of the first cutting force.

In an aspect, machine tool 10 may perform, for each cutting edge, the process of detecting chipping of tool 134. In another aspect, machine tool 10 may perform, for each tool, the process of detecting chipping of tool 134. In this case, machine tool 10 may use an average value or an integral value of the resistances of all cutting edges of tool 134. Further, in another aspect, machine tool 10 may simultaneously perform the process of detecting wear of tool 134 and the process of detecting chipping of tool 134. For example, it is assumed that the waveform of the cutting force of the first cutting edge has become larger than a reference waveform and the waveform of the cutting force of the second cutting edge has become smaller than the reference waveform. In this case, machine tool 10 may determine that the first cutting edge has been worn and the second cutting edge has been chipped.

In the processes of FIGS. 9 and 10, machine tool 10 may compare respective integral values of the waveforms of the cutting forces. In this case, in one example, machine tool 10 calculates an integral value of the amplitude of the first cutting edge included in the waveform of the first cutting force. Next, machine tool 10 calculates an integral value of the amplitude of the first cutting edge included in the waveform of the second cutting force. The calculation of the integral values may be performed for each cutting edge or for each tool. Next, machine tool 10 calculates a difference between these integral values. Next, machine tool 10 determines whether or not the difference between the integral values has increased to a predetermined first threshold value or more. When the difference between the integral values has increased to the predetermined first threshold value or more, machine tool 10 may determine that wear has occurred in the first cutting edge. Machine tool 10 also determines whether or not the difference between the integral values has decreased to a predetermined second threshold value or more. When the difference between the integral values has decreased to the predetermined second threshold value or more, machine tool 10 may determine that chipping has occurred in the first cutting edge.

In the processes of FIGS. 9 and 10, machine tool 10 may compare respective peak values of the waveforms of the cutting forces. In this case, in one example, machine tool 10 acquires the peak value of the amplitude of the first cutting edge included in the waveform of the first cutting force. Next, machine tool 10 acquires the peak value of the amplitude of the first cutting edge included in the waveform of the second cutting force. Next, machine tool 10 calculates a difference between these peak values. Next, machine tool 10 determines whether or not the difference between the peak values has increased to a predetermined first threshold value or more. When the difference between the peak values has increased to the predetermined first threshold value or more, machine tool 10 may determine that wear has occurred in the first cutting edge. Machine tool 10 also determines whether or not the difference between the peak values has decreased to a predetermined second threshold value or more. When the difference between the peak values has decreased to the predetermined second threshold value or more, machine tool 10 may determine that chipping has occurred in the first cutting edge.

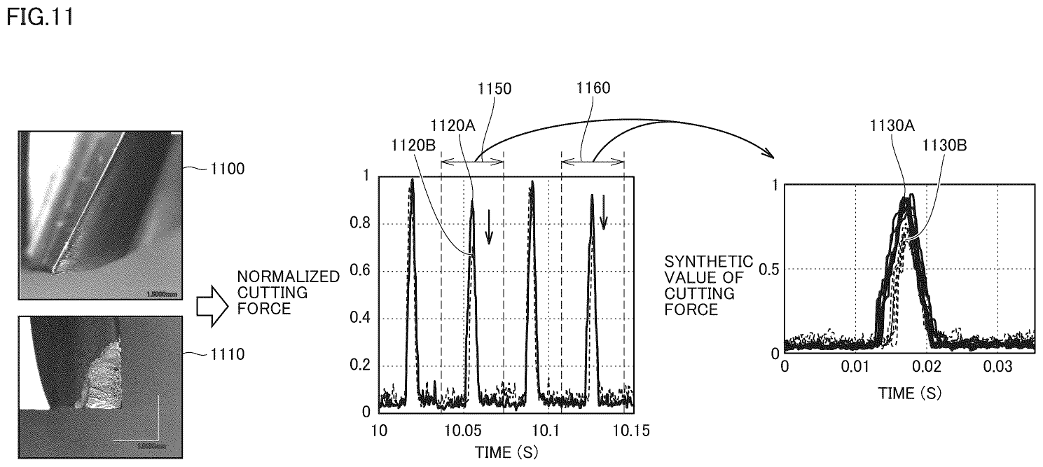

FIG. 11 is a diagram showing an example of integration of respective waveforms of cutting forces to be compared with each other. As described above with reference to FIGS. 6 to 10, machine tool 10 may compare the waveform of the first cutting force (reference waveform) with the waveform of the second cutting force. Each of the waveforms to be compared with each other (the waveforms of the first and second cutting forces) may be a synthetic value of a plurality of waveforms. A procedure for calculating an integral value of the waveforms is described with reference to FIG. 11.

It is assumed that tool 134 includes a first cutting edge and a second cutting edge. The first cutting edge is new as shown in a photograph 1100. The second cutting edge is chipped as shown in a photograph 1110. A waveform 1120A of the cutting force is a waveform before the second cutting edge is chipped (a waveform of the first cutting force). A waveform 1120B of the cutting force is a waveform after the second cutting edge is chipped (a waveform of the second cutting force).

Machine tool 10 may calculate, for each cutting edge, an integral value of waveforms. For example, the machine tool acquires waveform 1120A of the cutting force for a certain period of time. Then, machine tool 10 integrates waveforms (waveforms in sections 1150 and 1160, for example) of the second cutting edge included in waveform 1120A of the cutting force. Similarly, the machine tool acquires waveform 1120B of cutting force for a certain period of time. Then, machine tool 10 integrates waveforms (waveforms in sections 1150 and 1160, for example) of the second cutting edge included in waveform 1120B of the cutting force.

1130A indicates a waveform of the cutting force of the second cutting edge included in superimposed waveforms 1120A of the cutting force. Machine tool 10 can acquire a synthetic value of the waveforms of the cutting force of the second cutting edge before being chipped, by integrating these waveforms. 1130B indicates a waveform of the cutting force of the second cutting edge included in superimposed waveforms 1120B of the cutting force. Machine tool 10 can acquire a synthetic value of the waveforms of the cutting force of the second cutting edge after being chipped, by integrating these waveforms.

Machine tool 10 may compare the synthesized waveforms of the first cutting force with the synthetized waveforms of the second cutting force. The synthesized waveforms of the first cutting force and the synthesized waveforms of the second cutting force may be acquired for each cutting edge. The synthetic value may be an integral value, an average value, or a median value. Machine tool 10 can use the synthetic value to reduce an influence of a sudden change in resistance value (so-called noise) due any cause other than wear or chipping.

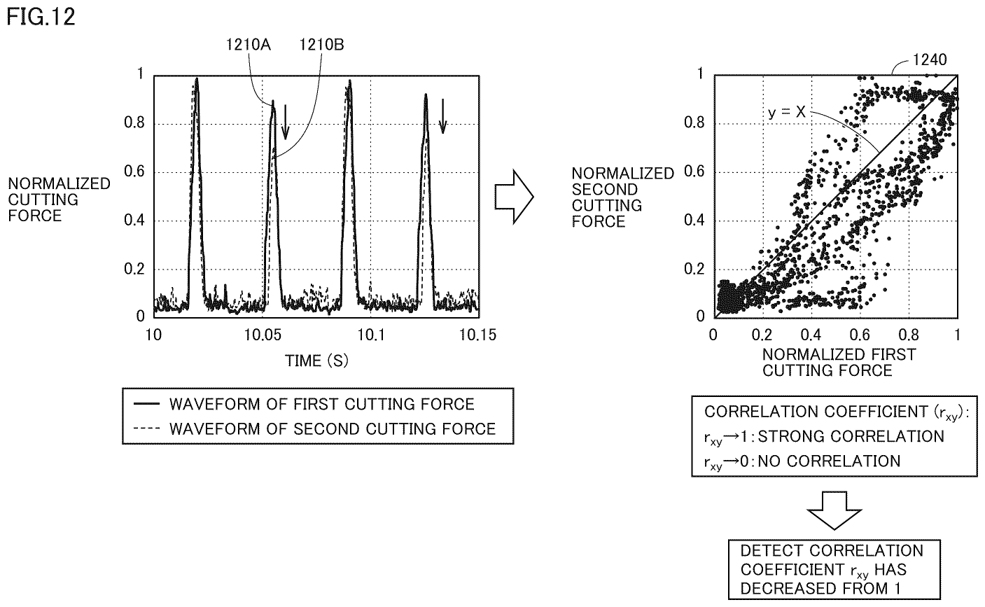

FIG. 12 is a diagram showing an example of a correlation between a waveform of the first cutting force and a waveform of the second cutting force. In the examples of FIGS. 6 to 11, machine tool 10 detects wear or chipping of tool 134 based on a difference in amplitude between the waveform of the first cutting force and the waveform of the second cutting force. Machine tool 10 can also detect chipping of tool 134 based on a change in correlation coefficient value of the waveform of the first cutting force and the waveform of the second cutting force.

A graph 1240 is obtained by plotting values of correlation coefficients of a waveform 1210A of the first cutting force and a waveform 1210B of the second cutting force. As the correlation coefficient is closer to 1, the first cutting force waveform 1210A and the second cutting force waveform 1210B have a stronger correlation. That is, the closer the correlation coefficient is to 1, the greater the similarity between the first cutting force waveform 1210A and the second cutting force waveform 1210B. On the contrary, as the correlation coefficient is farther from 1, the first cutting force waveform 1210A and the second cutting force waveform 1210B have a weaker correlation. That is, the closer the correlation coefficient is to 0, the greater the difference between the first cutting force waveform 1210A and the second cutting force waveform 1210B.

Machine tool 10 can detect chipping of tool 134 based on the fact that the value of the correlation coefficient has become equal to or less than a predetermined value. That is, machine tool 10 can detect chipping of tool 134, based on the fact that the value of the correlation coefficient has decreased from 1 by a predetermined value or more. In an aspect, correlation data 526 may include a threshold value for the value of the correlation coefficient for detecting chipping of tool 134. In this case, machine tool 10 can detect chipping of tool 134 based on the fact that the value of the correlation coefficient has decreased from 1 by the threshold value or more.

### C. Internal Process of Machine Tool 10

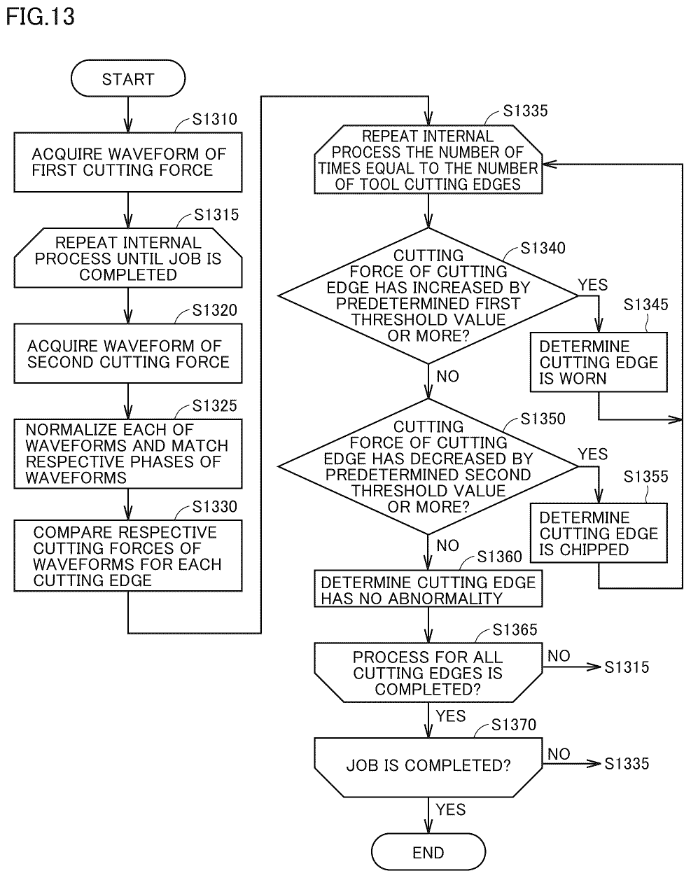

FIG. 13 is a diagram showing an example of an internal process of machine tool 10. In an aspect, processor 501 may read abnormality detection program 524 for performing the process of FIG. 13, from storage device 507 into RAM 503. Further, processor 501 may execute abnormality detection program 524 read into RAM 503. In another aspect, abnormality detection program 524 may be read from ROM 502 into RAM 503. In still another aspect, a part or all of the process may be implemented by a combination of circuit elements configured to perform the process. That is, machine tool 10 can implement the method described below by executing the program. Further, processor 501 may read machining program 522 and correlation data 526 into RAM 503 to execute or refer to it as required.

In step S1310, machine tool 10 acquires (measures) a waveform (reference waveform) of the first cutting force. The process in this step corresponds to the process of acquiring, as a reference waveform, waveform 620A of the first cutting force corresponding to position 630 on machining path 600A in first machining shown in FIG. 6.

In step S1315, machine tool 10 repeatedly performs the process in steps S1320 to S1370 until a job is completed. For example, it is assumed that the job includes an instruction to move tool 134 to make ten rounds on the same machining path. In this case, machine tool 10 acquires a waveform of the first cutting force in machining performed for the first time. In the second and subsequent machining, machine tool 10 repeatedly performs the process in steps S1320 to S1370 nine times.

In step S1320, machine tool 10 acquires (measures) the waveform of the second cutting force. The process in this step corresponds to the process of acquiring waveform 620B of the second cutting force corresponding to position 630 on machining path 600B in second and subsequent machining in FIG. 6.

In step S1325, machine tool 10 normalizes each of the waveforms (the waveforms of the first and second cutting forces), and further, matches respective phases of the waveforms with each other. In an aspect, machine tool 10 may normalize each of the waveforms, after matching respective phases of the waveforms. The process in this step corresponds to the processes in FIGS. 7 and 8.

In step S1330, machine tool 10 compares, for each cutting edge, the cutting forces of the waveforms. In step S1335, machine tool 10 repeatedly performs the process in steps S1340 to S1365 the number of times equal to the number of cutting edges of the tool.

In step S1340, machine tool 10 determines whether or not the cutting force of the cutting edge has increased by a predetermined first threshold value or more. More specifically, machine tool 10 compares the cutting force (amplitude) of a certain cutting edge in the waveform of the second cutting force with the cutting force (amplitude) of the cutting edge in the waveform of the first cutting force to acquire a difference therebetween. Machine tool 10 determines whether or not the difference (the increase of the cutting force) is equal to or greater than the predetermined first threshold value. When machine tool 10 determines that the cutting force of the cutting edge has increased by the predetermined first threshold value or more (YES in step S1340), the machine tool makes the control proceed to step S1345. Otherwise (NO in step S1340), machine tool 10 makes the control proceed to step S1350. In step S1345, machine tool 10 determines that the cutting edge is worn. The process in steps S1340 and S1345 corresponds to the process in FIG. 9.

In step S1350, machine tool 10 determines whether or not the cutting force of the cutting edge has decreased by a predetermined second threshold value or more. More specifically, machine tool 10 compares the cutting force (amplitude) of a certain cutting edge in the waveform of the second cutting force with the cutting force (amplitude) of the cutting edge in the waveform of the first cutting force to acquire a difference therebetween. Machine tool 10 determines whether or not the difference (the decrease of the cutting force) is equal to or greater than the predetermined second threshold value. When machine tool 10 determines that the cutting force of the cutting edge has decreased by the predetermined second threshold value or more (YES in step S1350), the machine tool makes the control proceed to step S1355. Otherwise (NO in step S1350), machine tool 10 makes the control proceed to step S1360. In step S1355, machine tool 10 determines that the cutting edge is chipped. The process in steps S1350 and S1355 corresponds to the process in FIG. 10. In step S1360, machine tool 10 determines that there is no abnormality in the cutting edge.

In step S1365, machine tool 10 determines whether or not the process for all cutting edges has been completed. When machine tool 10 determines that the process for all cutting edges has been completed (YES in step S1365), the machine tool makes the control proceed to step S1370. Otherwise (NO in step S1365), machine tool 10 makes the control proceed to step S1315.

In step S1370, machine tool 10 determines whether or not the job has been completed. When machine tool 10 determines that the job has been completed (YES in step S1370), the machine tool ends the process. Otherwise (NO in step S1370), machine tool 10 makes the control proceed to step S1335.

In an aspect, as described above with reference to FIG. 11, the waveform of the first cutting force and the cutting force of the second cutting edge may be a synthetic value of waveforms. In another aspect, as described above with reference to FIG. 12, machine tool 10 may determine (detect) wear or chipping of tool 134 based on the coefficient of correlation between the waveform of the first cutting force and the cutting force of the second cutting edge.

As described above, abnormality detection program 524 can be executed by processor 501 to cause machine tool 10 to: detect wear or chipping of tool 134, based on a waveform of a cutting force measured from an output signal from each of a plurality of strain sensors S1 to S4; measure a waveform of the first cutting force; measure a waveform of the second cutting force after measuring the waveform of the first cutting force; make a comparison between the waveform of the first cutting force and the waveform of the second cutting force; and detect wear of the tool based on a result of the comparison.

In an aspect, making the comparison between the waveform of the first cutting force and the waveform of the second cutting force includes matching respective phases of the waveform of the first cutting force and the waveform of the second cutting force with each other, and calculating a difference between the waveform of the first cutting force and the waveform of the second cutting force after the respective phases are matched with each other. Abnormality detection program 524 further causes the machine tool to detect chipping of the tool based on the difference between the waveform of the first cutting force and the waveform of the second cutting force after the respective phases are matched with each other.

Further, abnormality detection program 524 may cause machine tool 10 to perform a process of normalizing the waveform of the first cutting force and the waveform of the second cutting force. The process of acquiring (measuring) the waveform of the first cutting force and the waveform of the second cutting force may include a process of acquiring (measuring) a synthetic value of each of the waveforms of the first and second cutting forces.

### D. Modification

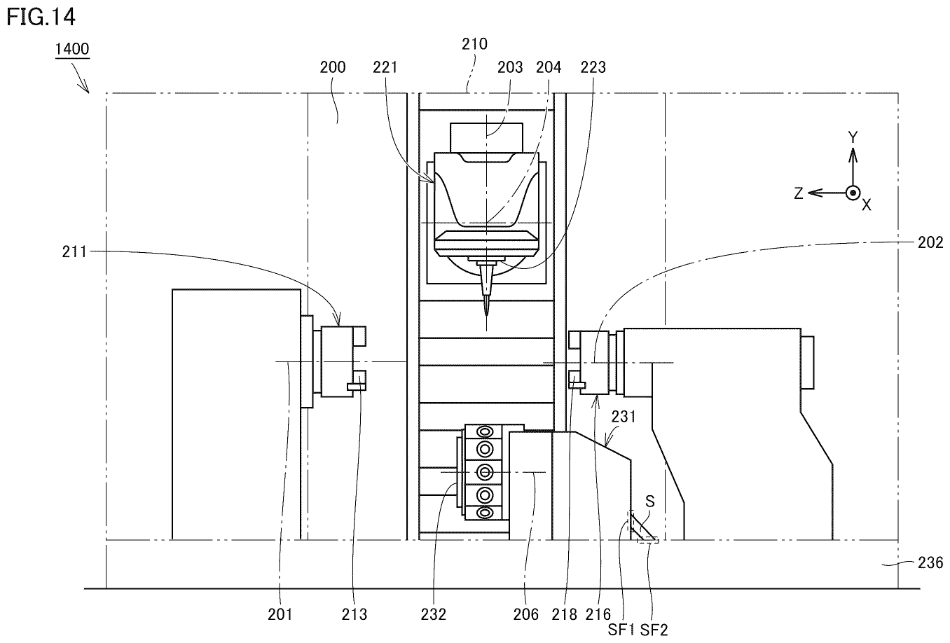

FIG. 14 is a diagram showing an example of a configuration of a machine tool 1400 according to a modification. The technique of the present disclosure may be used for any machine tool that machines a workpiece using a tool. Machine tool 1400 according to a modification is described with reference to FIG. 14.

Machine tool 1400 is a multifunctional machine having a turning function of machining a workpiece with a tool held in contact with the workpiece being rotated, and a milling function of machining a workpiece with a rotating tool held in contact with the workpiece. Machine tool 1400 includes a bed 236, a workpiece spindle 211, an opposing workpiece spindle 216, a tool spindle 221, and a cutting tool rest 231. Machine tool 1400 also includes a controller (not shown) corresponding to controller 50.

Bed 236 is a base member that supports workpiece spindle 211, opposing workpiece spindle 216, tool spindle 221, and cutting tool rest 231, for example, and is installed on the floor of a factory or the like. Bed 236 is formed from a metal such as cast iron.

Workpiece spindle 211 and opposing workpiece spindle 216 are configured to hold a workpiece. Workpiece spindle 211 and opposing workpiece spindle 216 are provided to face each other in the Z axis direction. Workpiece spindle 211 and opposing workpiece spindle 216 are mainly provided to rotate the workpiece during turning using a fixed tool. Workpiece spindle 211 is provided so as to be rotatable about a central axis 201 parallel to the Z axis. Opposing workpiece spindle 216 is provided so as to be rotatable about a central axis 202 parallel to the Z axis. Workpiece spindle 211 and opposing workpiece spindle 216 are provided with a first chuck mechanism 213 and a second chuck mechanism 218, respectively, for detachably grasping the workpiece.

Workpiece spindle 211 is fixed on bed 236. Opposing workpiece spindle 216 is provided so as to be movable in the Z axis direction by any of various feed mechanisms, guide mechanisms, servo motors, and the like.

Tool spindle 221 and cutting tool rest 231 are each configured to hold a tool for cutting a workpiece. Tool spindle 221 is provided above cutting tool rest 231.

Tool spindle 221 is provided so as to be rotatable about a central axis 203 extending in the vertical direction and parallel to the Y axis. Tool spindle 221 is provided with a clamp mechanism (not shown) for detachably holding the tool.

Further, tool spindle 221 is provided so as to be pivotable about a central axis 204 extending in the horizontal direction and parallel to the X axis orthogonal to the Z axis direction (B-axis pivoting). Tool spindle 221 pivotes, for example, within a range of ±120° with respect to a posture (a posture shown in FIG. 14) in which a spindle end surface 223 of tool spindle 221 faces downward.

Tool spindle 221 is supported on bed 236 by a column or the like (not shown). Tool spindle 221 is movable in the Y axis direction, the X axis direction, and the Z axis direction by any of various feed mechanisms, guide mechanisms, servo motors, and the like provided in a column or the like.

Cutting tool rest 231 has a so-called turret shape, to which a plurality of tools are attached radially, for performing pivot indexing. More specifically, cutting tool rest 231 includes a pivotable portion 232. Pivotable portion 232 is provided to be pivotable about a central axis 206 parallel to the Z axis. A tool holder for holding tools is attached at a position spaced apart in the circumferential direction about central axis 206. Pivotable portion 232 pivots about central axis 206 to cause the tools held by the tool holder to move in the circumferential direction, to determine a tool to be used for machining a workpiece.

Cutting tool rest 231 is supported on bed 236 by a saddle or the like, which is not shown. Cutting tool rest 231 is provided to be movable in the Y axis direction and the Z axis direction by any of various feed mechanisms, guide mechanisms, servo motors, and the like provided in a saddle or the like. Note that cutting tool rest 231 may be provided to be movable in the Z axis direction and an obliquely upward/downward direction orthogonal to the Z axis direction and including a vertical component. In this case, cutting tool rest 231 may be configured to move in the obliquely upward/downward direction orthogonal to the Z axis direction and including a vertical component, by being fed in the Y axis direction and the X axis direction simultaneously.

Each of tool spindle 221 and cutting tool rest 231 may hold a rotary tool or a fixed tool. The rotary tool is a tool that machines a workpiece while being rotated, such as drill, end mill, reamer, or the like. When the rotary tool is held on cutting tool rest 231, cutting tool rest 231 contains a motor that outputs rotation and a power transmission mechanism that transmits, to the rotary tool, the rotation output from the motor.

Machine tool 1400 further includes a splash guard 210. Splash guard 210 forms an external appearance of machine tool 1400 and defines a machining area 200 for the workpiece.

Machine tool 1400 measures the cutting force applied to the tool, using a strain sensor S provided on cutting tool rest 231. One end of strain sensor S is coupled to a surface SF1 (first surface). Surface SF1 is a surface that forms a predetermined angle with the axial direction (i.e., the Z direction) of tool spindle 221, and is one surface on cutting tool rest 231. Typically, the predetermined angle is about 90 degrees. In one example, surface SF1 is one surface parallel to the XY plane.

The other end of strain sensor S is coupled to a surface SF2 (second surface). Surface SF2 is a surface that is not parallel to surface SF1. In other words, surface SF2 forms a predetermined angle with surface SF1. The predetermined angle is, for example, about 90 degrees. In one example, surface SF2 is a surface parallel to the axial direction (i.e., the Z direction) of tool spindle 221 and is one surface on cutting tool rest 231. Alternatively, surface SF2 is a surface parallel to the axial direction of tool spindle 221 and is one surface on the surface on which cutting tool rest 231 is mounted (that is, on bed 236). Typically, surface SF2 is orthogonal to surface SF1. Strain sensor S detects the degree of strain of cutting tool rest 231 during machining. Machine tool 1400 measures the cutting force applied to the tool of cutting tool rest 231, from the output value of strain sensor S, based on a predetermined correlation between the output value of strain sensor S and the cutting force. Machine tool 1400 can acquire a predetermined correlation between the output value of strain sensor S and the cutting force, by referring to correlation data 526. Machine tool 1400 performs a process similar to the process described above with reference to FIGS. 6 to 13, based on the acquired (measured) cutting force. Thus, machine tool 1400 can detect wear or chipping of the tool on cutting tool rest 231.

### E. Conclusion

As described above, the machine tool according to the present embodiment measures a waveform of a first cutting force to be used as a reference waveform. The machine tool also measures a waveform of a second cutting force after measuring the waveform of the first cutting force. The machine tool also matches respective phases of the waveform of the first cutting force and the waveform of the second cutting force with each other. Further, the machine tool compares the waveform of the first cutting force with the waveform of the second cutting force. Furthermore, the machine tool detects wear of the tool based on the result of the comparison. In this way, the machine tool can easily detect wear of the tool based on the output signal of the strain sensor.

In an aspect, the machine tool matches respective phases of the waveform of the first cutting force and the waveform of the second cutting force with each other. The machine tool also calculates a difference between the waveform of the first cutting force and the waveform of the second cutting force after matching respective phases of the waveforms with each other. Further, the machine tool detects chipping of the tool based on a difference between the waveform of the first cutting force and the waveform of the second cutting force after matching respective phases of the waveforms. In this way, the machine tool can easily detect chipping of the tool based on the output signal of the strain sensor.

Further, in another aspect, the machine tool may compare, for each cutting edge of the tool, the waveform of the first cutting force with the waveform of the second cutting force. Thus, the machine tool can detect wear or chipping of each cutting edge of the tool. Further, the machine tool normalizes the waveform of the first cutting force and the waveform of the second cutting force.

As to the embodiments of the present invention described above, it should be construed that the embodiments disclosed herein are given by way of illustration in all respects, not by way of limitation. It is intended that the scope of the present invention is defined by claims, not by the description above, and encompasses all modifications and variations equivalent in meaning and scope to the claims.

What is claimed is:

1. A machine tool capable of cutting a workpiece using a tool, the machine tool comprising:
a spindle that causes the tool to rotate;
a housing that contains the spindle;
a plurality of strain sensors provided on the housing; and
a detector that detects wear or chipping of the tool, based on a waveform of a cutting force measured from an output signal from each of the plurality of strain sensors, wherein
the detector
measures a waveform of a first cutting force,
measures a waveform of a second cutting force, after measuring the waveform of the first cutting force,
makes a comparison between the waveform of the first cutting force and the waveform of the second cutting force, and
detects wear of the tool based on a result of the comparison.

2. The machine tool according to claim 1, wherein
making the comparison between the waveform of the first cutting force and the waveform of the second cutting force includes:
matching respective phases of the waveform of the first cutting force and the waveform of the second cutting force with each other; and
calculating a difference between the waveform of the first cutting force and the waveform of the second cutting force after the respective phases are matched with each other, and
the detector detects chipping of the tool, based on the difference between the waveform of the first cutting force and the waveform of the second cutting force after the respective phases are matched with each other.

3. The machine tool according to claim 1, wherein the detector normalizes the waveform of the first cutting force and the waveform of the second cutting force.

4. The machine tool according to claim 1, wherein the detector detects wear of the tool, based on a fact that an amplitude of the waveform of the second cutting force is larger than an amplitude of the waveform of the first cutting force, by a predetermined threshold value or more.

5. The machine tool according to claim 2, wherein the detector detects chipping of the tool, based on a fact that an amplitude of at least a part of the waveform of the second cutting force is smaller than an amplitude of at least a corresponding part of the waveform of the first cutting force, by a predetermined threshold value or more.

6. The machine tool according to claim 2, wherein
the tool includes a plurality of cutting edges,
each of the waveform of the first cutting force and the waveform of the second cutting force includes a plurality of amplitudes corresponding respectively to the plurality of cutting edges, and
detecting wear or chipping of the tool includes comparing respective amplitudes corresponding to the same cutting edge that are included in the waveform of the first cutting force and the waveform of the second cutting force, respectively.

7. The machine tool according to claim 1, wherein the waveform of the first cutting force and the waveform of the second cutting force are each a waveform of a cutting force at a position with the same machining condition, on a machining path for the workpiece.

8. A control method for a machine tool capable of cutting a workpiece using a tool, the machine tool comprising:
a spindle that causes the tool to rotate;
a housing that contains the spindle; and
a plurality of strain sensors provided on the housing, the control method comprising:
detecting wear or chipping of the tool, based on a waveform of a cutting force measured from an output signal from each of the plurality of strain sensors;
measuring a waveform of a first cutting force;
measuring a waveform of a second cutting force, after measuring the waveform of the first cutting force;
making a comparison between the waveform of the first cutting force and the waveform of the second cutting force; and
detecting wear of the tool based on a result of the comparison.

9. The control method according to claim 8, wherein
making the comparison between the waveform of the first cutting force and the waveform of the second cutting force includes:
matching respective phases of the waveform of the first cutting force and the waveform of the second cutting force with each other; and
calculating a difference between the waveform of the first cutting force and the waveform of the second cutting force after the respective phases are matched with each other, and
the control method further comprises detecting chipping of the tool, based on the difference between the waveform of the first cutting force and the waveform of the second cutting force after the respective phases are matched with each other.
